(19) United States
(12) Patent Application Publication
(10) Pub. No.: US 2007/0150523 A1
(43) Pub. Date: Jun. 28, 2007

(54) Method for the creation of a documentary chain and the updating thereof based on a structured model

(75) Inventors: Arnaud Bailleul, Toulouse (FR); Thierry Le-Saux, Cugnaux (FR)

Correspondence Address: LOWE HAUPTMAN GILMAN & BERNER, LLP, 1700 DIAGNOSTIC ROAD, SUITE 300, ALEXANDRIA, VA, 22314, US

(73) Assignee: THALES, 92 200 NEUILLY SUR SEINE FRANCE (FR)

(21) Appl. No.: 10/583,366

(22) PCT Filed: Dec. 8, 2004
(86) PCT No.: PCT/EP04/53349

§ 371 Date: Jun. 19, 2006

(30) Foreign Application Priority Data
Dec. 19, 2003 (FR) 03/15037

(51) Int. Cl. G06F 17/30; G06F 7/00; G06F 17/00

(52) U.S. Cl. 707/201; 715/530; 715/513; 715/511; 707/100

(57) ABSTRACT

The present invention relates to a method for the production of a documentary chain and for the updating thereof on the basis of a structured model, and according to a characteristic, one starts from a structured model from which relevant fragments are extracted, the final document is thereafter architectured in a text processing format by siphoning off from among these fragments those necessary and by arranging them as desired, and thus for each of the fragments generated then inserted a dynamic link is established between its location in the documentation and its physical file arising from automatic generation.

### CROSS-REFERENCE TO RELATED APPLICATIONS

The present Application is based on International Application No. PCT/EP2004/053349, filed on Dec. 8, 2004, which in turn corresponds to FR 03/15037 filed on Dec. 19, 2003, and priority is hereby claimed under 35 USC §119 based on these applications. Each of these applications are hereby incorporated by reference in their entirety into the present application.

### BACKGROUND OF THE INVENTION

1) Field of the Invention

The present invention pertains to a method for the production of a documentary chain and for the updating thereof on the basis of a structured model.

2) Description of Related Art

There exist numerous automatic documentation generators based on a structured model, but they are overly rigid from the point of view of the organization of the document that they create, and they do not make it possible to carry out automatic updating of the document following modifications of the model. Such automation could enormously simplify the task of the operator who is charged therewith and save him a lot of time, since the manual updating of documentation generated on the basis of a structured model can be very lengthy and irksome, in particular when this model is complex and voluminous.

### SUMMARY OF THE INVENTION

The present invention is aimed at a method for the production of a documentary chain on the basis of a structured model, making it possible to organize the document that it produces in any way whatsoever, and making it possible to carry out its updating automatically.

The method in accordance with the invention is characterized in that it comprises the following steps: one starts from a structured model from which relevant documentary fragments are extracted, the final document is thereafter architectured in a text processing format by siphoning off from among these fragments those necessary and by arranging them as desired. Thus for each of the fragments generated then inserted a dynamic link is established between its location in the documentation and its physical file arising from automatic generation.

According to a characteristic of the invention, it is possible to use similarly the “RHAPSODY-DOC” tool with “DOORS” for the generation of the documentary fragments processing the information around the requirements, then the combination of “RHAPSODY-DOC” with a text processing so as to insert these DOORS fragments and architecture its final document.

Subsequently in the document, for greater convenience, the expression “requirement documentary fragments” will refer to the documentary fragments arising from DOORS and “documentary fragments of the model” the documentary fragments arising from the structured model. “Documentary fragment”, generally, will be understood to mean a fragment of the two types mixed.

### BRIEF DESCRIPTION OF THE DRAWINGS

The present invention will be better understood on reading the detailed description of a mode of implementation, taken by way of nonlimiting example and illustrated by the appended drawing, in which:

FIG. 1 is a graphics interface of a macro of a text processing showing the tree of the documentary fragments after the phase of generation of the fragments of the method of the invention,

FIG. 2 is a view of the interface of FIG. 1 showing the filter functionality for the documentary fragments facilitating the search for fragments,

FIG. 3 is a view of a graphics interface of the “DOORS” tool in which are defined the requirements information that one wants to transfer to the documentation, according to a variant of the method of the invention,

FIGS. 4, 5 and 6 are successive views of a graphics interface of a “WORD” text processing in which the sketch of the documentary fragment is defined, namely the layout of the DOORS requirements information, such as one wants to see it distributed in the requirements documentary fragments, after documentary generation, in accordance with the method of the invention,

FIG. 7 is a view of one of the requirement documentary fragments arising from the documentary generation and taking into account the sketch defined in FIGS. 4, 5 and 6 and the DOORS requirements data of FIG. 3, and

FIG. 8 is a view of a graphics interface of the “DOORS” tool implemented by the method of the invention to run the generation of requirements documentary fragments from DOORS.

### DETAILED DESCRIPTION OF THE INVENTION

The method of the invention makes it possible to easily generate a documentation, for example in the WORD or RTF format, on the basis of documentary fragments originating from a UML model (software architecture information) and, in an optional manner, of a “DOORS” module (requirements traceability information) which is a tool for managing requirements from the company TELELOGIC.

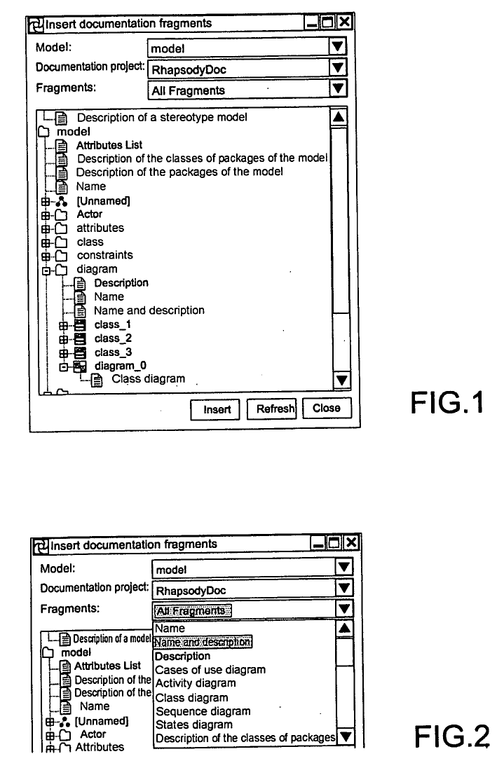

The final documentation obtained comprises parts arising from the automatic generation, but also textual parts (manual free text) included between the fragments generated. A WORD macro makes it possible to run a graphics interface which organizes all the documentary fragments generated and makes it possible to select one of them, then to include it very easily in a document in the WORD format (see FIG. 1).

In detail, the method of the invention proceeds in the following manner:
1) The user makes use of a modeling tool such as <<RHAPSODY>> from the company I-LOGIX. He loads under RHAPSODY the model from which he desires to derive documentation (in the example described below, this model is referred to quite simply as “model”). He runs “RHAPSODY-DOC” through the “TOOLS” menu of RHAPSODY. He generates with the aid of RHAPSODY-DOC, in a manner known per se, the documentary fragments of the model that he desires to include in the final documentation.
2) (Optional step—see detailed description of the variant method below) The user makes use of a requirements management tool such as <<DOORS>> from the company TELELOGIC. He loads under DOORS the module from which he desires to derive the information for the final documentation (in the example described below, this module is referred to quite simply as “module”). He runs “RHAPSODY-DOC” through the “DOORS Customs” menu of DOORS. He generates with the aid of RHAPSODY-DOC, in a manner known per se, the documentary fragments of the requirements that he desires to include in the final documentation.
3) Then, he opens an empty document (or a document of the type of his documentation benchmark) of a text processing, which is “WORD” in the present case.
4) The user clicks on the button “Inserting a fragment” of the WORD toolbar relating to RHAPSODY-DOC so as to run the WORD macro which opens a window “Insert fragment documentation”. The user selects from this interface the model wherein his documentary information in the “Model” options box is located. As specified above, this model is referred to as “model”. He thereafter selects his generator of documentary fragments from the “Project Documentation” options box. In the example described here, this is RHAPSODY-DOC. A tree then appears containing all the documentary fragments generated previously (see FIG. 1).
5) Then, he selects a fragment from the tree whose tree structure echos the architecture of the packages of the starting UML model. It remains for him to position the cursor in the WORD document at the location where the fragment must be inserted, then to click on the “Insert” button, which is situated in the lower banner of the interface.

The number of documentary fragments can become very significant. To facilitate the search for the fragment to be inserted, the user has the possibility of filtering the fragments proposed in the “Fragments” options box of the graphics interface, as represented in FIG. 2. This filtering is done on the basis of the type of fragments generated. In the example of FIG. 2, the name of the types of fragments “Name and description” is set to reverse video by passing the cursor over their name, and it then suffices to click on this name to carry out the desired filtering. The tree displayed then contains only the fragments of the desired type, hence greatly limiting their number and accelerating the search and the selection of the desired fragment.

To perform the updating of an existing document, the user, after having made modifications in his UML model, runs the documentary generation program from RHAPSODY and, in an optional manner, DOORS so as to reupdate its base of documentary fragments. Thereafter, it uses the “Update” function of the WORD macro. All the previously inserted fragments will be automatically updated and at the proper location in the final document. It will be noted that if new fragments are necessary, they will have to be inserted manually.

According to a variant of the method of the invention, it is possible to recover the information arising from the aforesaid “DOORS” tool. There is generated for each requirement of a DOORS module a requirement documentary fragment that it is possible thereafter to insert at the desired location in the final document.

The generation of documentary fragments is performed on the basis of a DOORS view of a module wherein is defined the whole of the information that one desires to bring up in the WORD document. The user defines the way in which he desires to represent this information in WORD with the aid of WORD “sketches” (“.dot” files of presentation models) and of WORD bookmarks. In this template, one constructs the generic representation that one desires to give to the objects contained in the associated view. A DOORS view is composed of columns, each column having a title. The “mapping” (the link) between a DOORS view (graphics interface of the DOORS tool) and the associated WORD sketch is performed through bookmarks, each bookmark bearing the name of the column that it represents.

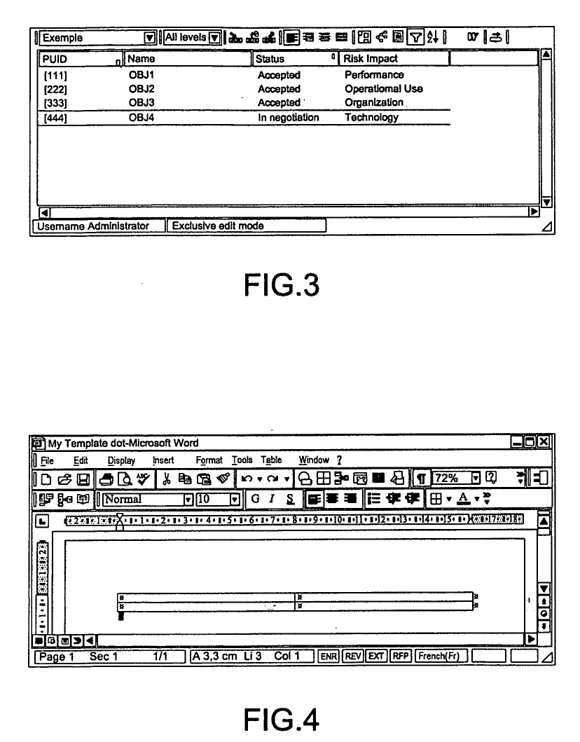

Represented in FIG. 3 is a DOORS view. In this view, there are four columns, respectively entitled “PUID” (identity of the objects), “Name” (names of the objects), “Status” (state of the objects), and “Impact Risk” (impact on the various elements of the model considered). The UML objects appearing in the view and on which requirements are placed are respectively referenced OBJ1 to OBJ4. The state of the first three is “Accepted”, while that of the last is “Under negotiation” (undergoing processing). Their respective impacts are: “Performance”, “Operational use”, “Organization” and “Technology”.

The user opens a WORD file and records it under an arbitrary name with the extension “.dot”, for example “My sketch.dot”, as represented in FIG. 4. Then, he defines in this file the general aspect that he desires to give to the objects contained in the DOORS view (a table with two rows and two columns, as represented in FIG. 4). Thereafter, he inserts into the WORD document a specific bookmark for each DOORS attribute that he desires to extract. He inserts this bookmark at the location where he desires to see the appearance of the content of the attribute considered for each of the DOORS requirements (for example the requirement [ 111] applying to a UML object, which is then OBJ1).

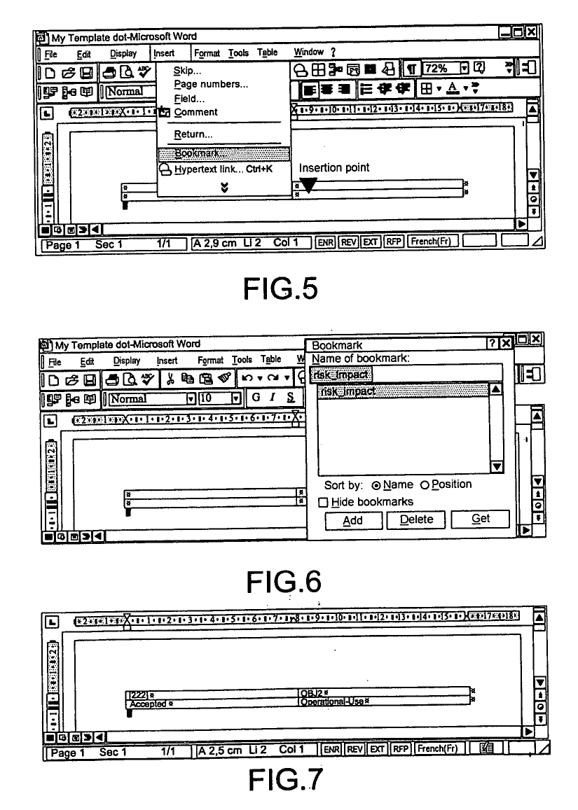

Represented in FIGS. 5 to 7 is an exemplary insertion of the “Impact Risk” column for the object OBJ2. FIG. 5 represents how the user designates the insertion point for a bookmark. In FIG. 6, the user chooses the name of the bookmark (“Impact risk” in the present case) in the pop-up window for inserting WORD bookmarks. By proceeding in the same manner for the other columns of the DOORS view, the user obtains a sketch “My sketch.dot” which, after generation on the basis of DOORS, gives four documentary fragments (one per requirement) containing the specified information (the fragment generated for the requirement [222] applied to the UML object OBJ2, is represented in FIG. 7).

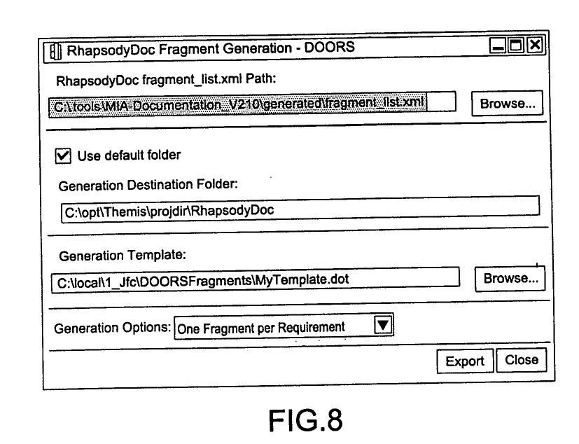

The generation of documentary fragments via “RHAPSODY-DOC GENERATION” operates only in the context where requirements identified in a Rhapsody model have been imported under DOORS by using the import function of “DOORS Custom”. In this case, the requirement module created following this import is correctly implemented for documentary generation. On the basis of this module, “RHAPSODY-DOC” can be triggered from the “DOORS Custom” menu of DOORS. The interface represented in FIG. 8 is then run.

The “RHAPSODY-DOC fragment_list Path” field makes it possible to specify the path of the file used by RHAPSODY-DOC to list the documentary fragments generated from RHAPSODY or DOORS. In general, this file is situated under the “generated” directory of the RHAPSODY-DOC installation directory.

The “Generation Destination Folder” field makes it possible to specify the path of the directory where the documentary fragments will be generated. If the specified path has not yet been created, it will be during export. The “Sketch Generation” field makes it possible to specify the WORD template (of the style of the file “My sketch.dot”) to be used for the generation of the documentary fragments. The “Generation options” field proposes two possible types of generation:

The first, “One Fragment per Requirement” (represented in FIG. 8), makes it possible to generate one documentary fragment per requirement,

The second, “One Fragment per UML Container” (not represented in FIG. 8), makes it possible to generate one fragment per UML element containing requirements in the model. Each fragment generated contains the list of the requirements contained in these UML elements.

Once generation has terminated, it suffices to return under WORD and to use the WORD macro of RHAPSODY-DOC. The fragments corresponding to the UML model concerned coming from DOORS are classed in the “Documentation Project” category of RHAPSODY and DOORS. This category contains only the requirements documentary fragments, but the tree in which they are placed is the same as that in the UML model.

1-9. (canceled)

10. A method for the production of a documentary chain on the basis of a structured model, comprising the following steps:
loading of a structured model into a modeling tool;
generating of documentary fragments of the model;
selecting of the model including the documentary information and of the generator of documentary fragments;
inserting of the documentary fragments generated into the documentary structure of the documentary chain.

11. The method as claimed in claim 10, wherein the structured model is a UML model.

12. The method as claimed in claim 10, wherein the update of the documentation is performed with the aid of dynamic links established for each fragment generated between its location in the documentary chain and its physical file arising from the automatic documentary generation.

13. The method as claimed in claim 1, wherein the model is produced with the aid of the “RHAPSODY” tool and that “RHAPSODY-DOC” is used to generate the documentary fragments that one desires to include in the final documentation.

14. The method as claimed in claim 13, wherein the documentary fragments generated are inserted into a document opened in a text processing.

15. The method as claimed in claim 10, wherein the “RHAPSODY-DOC” tool is used with “DOORS” for the generation of the documentary fragments processing the information around the requirements, then the combination of “RHAPSODY-DOC” with a text processing so as to insert these DOORS fragments and architecture its final document.

16. The method as claimed in claim 10, wherein the “RHAPSODY-DOC” tool is used with “DOORS” and a text processing for the documentary generation.

17. The method as claimed in claim 10, wherein the final documentation comprises manual free text included between the fragments generated.

18. The method as claimed in claim 10, wherein the types of fragments generated are filtered before their insertion into the documentary chain.
